(19) United States
(12) Patent Application Publication
(10) Pub. No.: US 2026/0188816 A1
(43) Pub. Date: Jul. 2, 2026

(54) METHOD FOR MANUFACTURING BATTERY MODULE

(71) Applicant: SUBARU CORPORATION, Tokyo (JP)

(72) Inventor: Tomoya TATEISHI, Tokyo (JP)

(21) Appl. No.: 19/419,916

(22) Filed: Dec. 15, 2025

(30) Foreign Application Priority Data
Dec. 27, 2024 (JP) 2024-232095

(51) Int. Cl. H01M 50/244; H01M 50/213

(52) U.S. Cl. CPC H01M 50/244; H01M 50/213

(57) ABSTRACT

Provided is a method of manufacturing a battery module including: a stacked body including stacked units each including first and second cell groups in which cells extending in a first direction are arranged in a second direction, and a temperature control plate; and a cover bonded to first end surfaces in the first direction of the cells. The method includes: applying a larger amount of adhesive to the first end surfaces than an amount for bonding the first end surfaces and the cover; and bonding the first end surfaces and the cover with the adhesive between the first end surfaces and the cover by pressing the cover against the first end surfaces, and filling at least a part of a gap formed by an inner surface of the cover and side surfaces of the cells with the adhesive overflowing from between the first end surfaces and the cover.

### CROSS-REFERENCE TO RELATED APPLICATIONS

The present application claims priority from Japanese Patent Application No. 2024-232095 filed on Dec. 27, 2024, the entire contents of which are hereby incorporated by reference.

### BACKGROUND

The present disclosure relates to a method for manufacturing a battery module.

Conventionally, there has been known an electric vehicle that can travel by a motor using electric power stored in a battery module in a battery pack. For example, Japanese Unexamined Patent Application Publication (Translation of PCT Application) (JP-T) 2023-502274 discloses a battery pack that is disposed at the center of a lower portion of a vehicle body of an electric vehicle and includes battery modules. The battery module of JP-T No. 2023-502274 includes a stacked body in which units including a first cell group, a second cell group, and a temperature control plate disposed between the first cell group and the second cell group are stacked.

### SUMMARY

An aspect of the disclosure provides a method of manufacturing a battery module. The battery module includes a stacked body and a cover. The stacked body includes stacked units. The stacked units each include a first cell group and a second cell group, and a temperature control plate. In the first cell group and the second cell group, cells extending in a first direction are arranged in a second direction orthogonal to the first direction. The temperature control plate is disposed between the first cell group and the second cell group and extends in the second direction. The cover is bonded to respective first end surfaces of the cells that are in the first direction. The method includes applying adhesive to first end surfaces of cells, bonding the first end surfaces and the cover, and filling a gap with the adhesive. A larger amount of adhesive is applied to the first end surfaces of the cells than an amount for bonding the first end surfaces and the cover. The first end surfaces and the cover are bonded with the adhesive between the first end surfaces and the cover by pressing the cover against the first end surfaces to which the adhesive is applied. At least a part of a gap formed by an inner surface of the cover and respective side surfaces of the cells is filled with the adhesive overflowing from between the first end surfaces and the cover.

### BRIEF DESCRIPTION OF THE DRAWINGS

The accompanying drawings are included to provide a further understanding of the disclosure and are incorporated in and constitute a part of this specification. The drawings illustrate an embodiment and, together with the specification, serve to describe the principles of the disclosure.

FIG. 1 is a cross-sectional view illustrating an example of a configuration of a battery module according to an embodiment of the disclosure;

FIG. 2 is a schematic view illustrating a configuration of a stacked body;

FIG. 3 is a flowchart for describing a method for manufacturing the battery module according to the embodiment;

FIG. 4 is a flowchart for describing a flow of an assembling step;

FIG. 5 is a schematic view illustrating an example of an application step of an upper cover assembling step;

FIG. 6 is a schematic view illustrating an example of a pressing step of an upper cover assembling step; and

FIG. 7 is a schematic view illustrating an example of a state after the pressing step of the upper cover assembling step is performed.

### DETAILED DESCRIPTION

In a manufacturing process of a battery module, potting may be performed after the stacked body is accommodated in a case. In potting, a fluid filler is injected into the case, and the injected filler is cured to fill gaps of the stacked body with the filler. The potting is performed to fix the position of each member inside the case. However, for example, if there is a gap in the vicinity of the cover that is located below the stacked body at the time of performing potting, the filler may flow out of the stacked body through the gap. When the filler flows out, filling of the filler becomes insufficient, and for example, the position of each member may not be appropriately fixed.

Therefore, it is desirable to provide a method for manufacturing a battery module capable of suppressing outflow of a filler.

Hereinafter, an embodiment of the disclosure will be described in detail with reference to the accompanying drawings. Specific dimensions, materials, numerical values, and the like illustrated in such an embodiment are merely examples for facilitating understanding of the disclosure, and do not limit the disclosure unless otherwise specified. Note that, in the present specification and the drawings, elements having substantially the same function and configuration are denoted by the same reference numerals, and redundant description is omitted, and elements not directly related to the disclosure are not illustrated.

### Battery Module

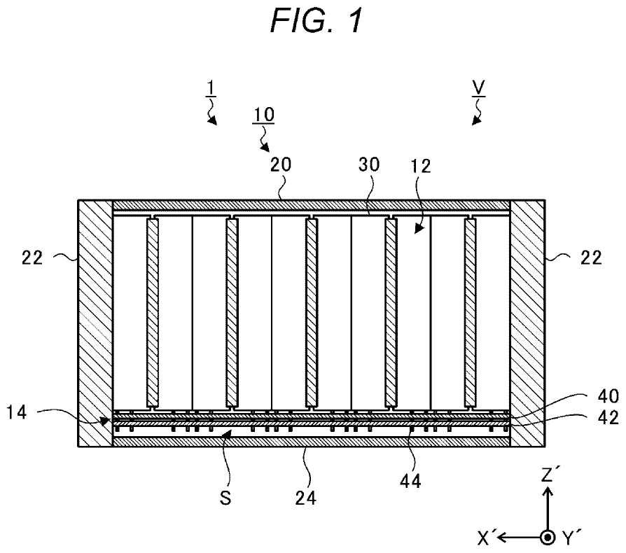

FIG. 1 is a cross-sectional view illustrating an example of a configuration of a battery module 1 according to the present embodiment. In FIG. 1, an X′ direction indicates a width direction of the battery module 1, a Y′ direction indicates a length direction of the battery module 1, and a Z′ direction indicates a height direction of the battery module 1.

The battery module 1 may be mounted on a vehicle V such as an electric vehicle including a motor generator as a drive source. Note that the vehicle V is not limited to an electric vehicle, and may be a hybrid electric vehicle including a motor generator and an engine as a drive source. In addition, the battery module 1 is not limited to be mounted on the vehicle V, and may be mounted on various apparatuses.

The battery module 1 includes a case 10, a stacked body 12, and a bus bar module 14.

The case 10 forms a housing space S therein. The case 10 includes an upper cover 20, a side plate 22, and a lower cover 24. A space surrounded by the upper cover 20, the side plate 22, and the lower cover 24 is a housing space S. The stacked body 12 and the bus bar module 14 are accommodated in the housing space S inside the case 10. The stacked body 12 is positioned on an upper side in the Z′ direction with respect to the bus bar module 14.

The upper cover 20 is disposed on an upper side in the Z′ direction with respect to the stacked body 12. The upper cover 20 has a rectangular flat plate shape. The upper cover 20 covers the upper side of the stacked body 12 in the Z′ direction.

The lower cover 24 is disposed below the bus bar module 14 in the Z′ direction. The lower cover 24 has a rectangular flat plate shape. The lower cover 24 covers the lower side of the bus bar module 14 in the Z′ direction.

A pair of side plates 22 is disposed on both sides in the X′ direction with respect to the stacked body 12 and the bus bar module 14. The side plate 22 has a rectangular flat plate shape. The side plate 22 covers both sides of the stacked body 12 and the bus bar module 14 in the X′ direction. The upper cover 20 is coupled to an upper end of the side plate 22 in the Z′ direction. The lower cover 24 is coupled to a lower end of the side plate 22 in the Z′ direction.

The stacked body 12 includes cells 30. The cells 30 are single batteries of chargeable/dischargeable secondary batteries such as lithium ion batteries. The cells 30 are each assumed to be formed in a columnar shape, but are not limited to a columnar shape, and may be formed in various shapes such as a prismatic shape and an elliptical columnar shape. Each of the cells is disposed upright so as to extend in the height direction (Z′ direction in FIG. 1) of the battery module 1. The cell 30 has positive and negative electrodes. The stacked body 12 will be described in detail later.

The bus bar module 14 includes a bus bar plate 40, bus bars 42, and wires 44. The bus bar plate 40 holds the bus bars 42. The bus bar 42 is formed of a conductive material in a sheet shape or a plate shape. Each of the wires 44 electrically couples one of the electrodes of one of the cells 30 and one of the bus bars 42. The bus bar 42 electrically couples the electrodes of the cells 30 via the wire 44. The cells 30 are coupled in parallel and in series via the wires 44 and the bus bars 42.

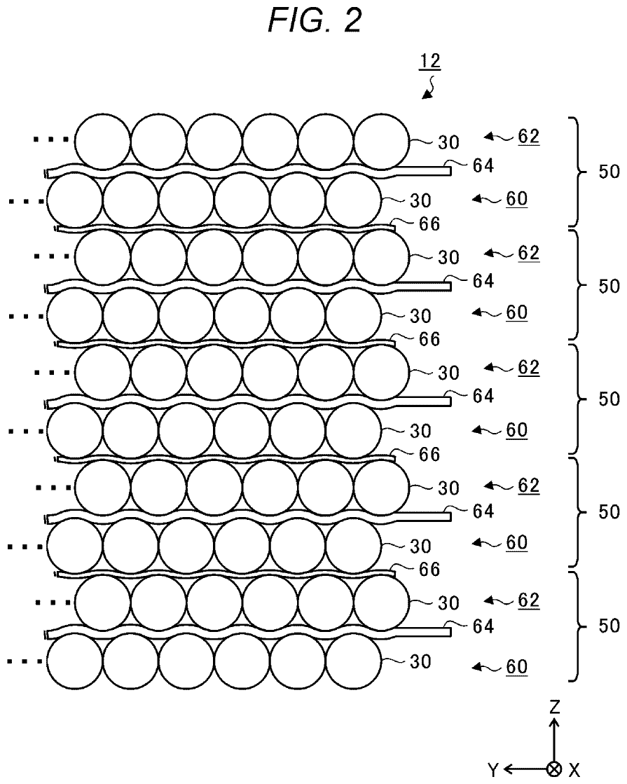

FIG. 2 is a schematic view illustrating a configuration of the stacked body 12. FIG. 2 illustrates a state in which the stacked body 12 illustrated in FIG. 1 is viewed from the Z′ direction in FIG. 1. In FIG. 2, an X direction is a first direction corresponding to an extending direction of the cell 30. In FIG. 2, a Y direction is a second direction orthogonal to the X direction, and corresponds to a direction in which the cells 30 are arranged. In FIG. 2, a Z direction is a third direction orthogonal to the X direction and the Y direction, and corresponds to a stacking direction of units 50 described later. The X direction in FIG. 2 corresponds to the Z′ direction in FIG. 1, the Y direction in FIG. 2 corresponds to the Y′ direction in FIG. 1, and the Z direction in FIG. 2 corresponds to the X′ direction in FIG. 1.

The stacked body 12 includes units 50. Each of the units 50 includes a first cell group 60, a second cell group 62, a temperature control plate 64, and an insulating sheet 66. The unit 50 may include two types including one including the insulating sheet 66 and one not including the insulating sheet 66. Hereinafter, for convenience of description, the first cell group 60 and the second cell group 62 may be collectively referred to simply as a cell group without distinction.

Each of the first cell group 60 and the second cell group 62 includes cells 30. Each of the cells 30 is disposed to extend in the first direction (X direction in FIG. 2). That is, the central axis of the cell 30 extends in the X direction.

The first cell group 60 is configured so that cells 30 extending in a first direction are arranged in a second direction (Y direction in FIG. 2) orthogonal to the first direction. In the example of FIG. 2, six cells 30 arranged in the Y direction are illustrated as the first cell group 60. However, the number of cells 30 constituting the first cell group 60 may be plural, and may be equal to or less than 5 or equal to or more than 7.

The second cell group 62 is a cell group configured separately from the first cell group 60, and is configured so that cells 30 extending in the first direction are arranged in a second direction (Y direction in FIG. 2) orthogonal to the first direction. The direction in which the cells 30 constituting the second cell group 62 are arranged is the same as the direction in which the cells 30 constituting the first cell group 60 are arranged. Hereinafter, for convenience of description, the direction in which the cells 30 constituting the cell group are arranged may be referred to as a parallel direction.

In the example of FIG. 2, six cells 30 arranged in the Y direction are illustrated as the second cell group 62. However, the number of cells 30 constituting the second cell group 62 may be plural, and may be equal to or less than 5 or equal to or more than 7. The number of cells 30 constituting the second cell group 62 is assumed to be the same as the number of cells 30 constituting the first cell group 60, but may be different from the number of cells 30 constituting the first cell group 60.

The temperature control plate 64 is disposed between the first cell group 60 and the second cell group 62. The temperature control plate 64 is formed in a wave plate shape. The temperature control plate 64 is disposed so that a longitudinal direction corresponding to a traveling direction of the wave in the temperature control plate 64 is the same direction as the parallel direction of the cells 30 of the cell group.

The first cell group 60 is coupled to a first surface of two surfaces of the temperature control plate 64 via an adhesive. Each of the cells 30 of the first cell group 60 is accommodated in a valley portion formed on the first surface of the temperature control plate 64. The second cell group 62 is coupled to a second surface of the two surfaces of the temperature control plate 64 via an adhesive. Each of the cells 30 of the second cell group 62 is accommodated in a valley portion formed on the second surface of the temperature control plate 64.

Although not illustrated, a flow path through which a heat medium can flow is formed inside the temperature control plate 64. The temperature control plate 64 performs heat exchange between the heat medium flowing through the internal flow path and the first cell group 60 and the second cell group 62. By this heat exchange, the temperatures of the first cell group 60 and the second cell group 62 are adjusted.

The unit 50 is formed by bonding at least the first cell group 60 to the first surface of the temperature control plate 64 and bonding the second cell group 62 to the second surface of the temperature control plate 64.

The units 50 are stacked in the third direction (Z direction in FIG. 2) orthogonal to the extending direction (first direction) of the cells 30 and the parallel direction (second direction) of the cells 30. That is, the third direction is a stacking direction in which the units 50 are stacked. When the units 50 are stacked, the first cell group 60 and the second cell group 62 are alternately arranged along the stacking direction.

The stacked body 12 is formed by stacking the units 50 with the insulating sheet 66 interposed therebetween. The insulating sheet 66 is formed in a sheet shape by an insulator. The insulating sheet 66 is positioned between the first cell group 60 of one unit 50 of the two adjacent units 50 and the second cell group 62 of the other unit 50. The insulating sheet 66 prevents cell groups adjacent in the stacking direction from coming into contact with each other.

The insulating sheet 66 is bonded to at least one of two cell groups sandwiching the insulating sheet 66 via an adhesive. The insulating sheet 66 may be bonded to a portion of at least one of the first cell group 60 or the second cell group 62 of the unit 50 opposite to the temperature control plate 64.

### Method for Manufacturing Battery Module

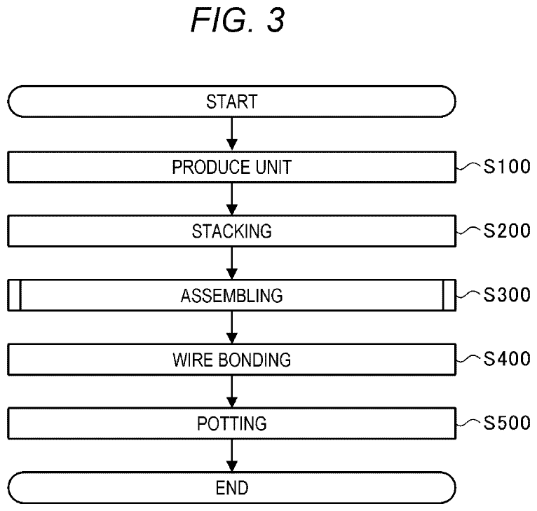

FIG. 3 is a flowchart illustrating a method for manufacturing the battery module 1 according to the present embodiment. As illustrated in FIG. 3, the method for manufacturing the battery module 1 includes a unit producing step S100, a stacking step S200, an assembling step S300, a wire bonding step S400, and a potting step S500. Each step of the method for manufacturing the battery module 1 may be performed by a manufacturing machine, may be performed by a person, or may be performed by cooperation of the manufacturing machine and the person.

In the unit producing step S100, a unit 50 including the first cell group 60, the second cell group 62, and the temperature control plate 64 is produced. For example, in the unit producing step S100, the first cell group 60 is bonded to the first surface of the temperature control plate 64 via an adhesive, and the second cell group 62 is bonded to the second surface of the temperature control plate 64 via an adhesive. In addition, in the unit producing step S100, for example, the insulating sheet 66 may be bonded to a portion of the second cell group 62 on a side opposite to the temperature control plate 64 via an adhesive.

In the stacking step S200, the units 50 thus produced are stacked with the insulating sheet 66 interposed therebetween to form the stacked body 12 (see FIG. 2).

In the assembling step S300, the bus bar module 14 and the produced stacked body 12 are assembled to at least some members constituting the case 10. The assembling step S300 will be described in detail later.

In the wire bonding step S400, the electrodes of the cells 30 and the bus bars 42 are coupled by the wires 44.

In the potting step S500, potting of filling the inside of the case 10 in which the stacked body 12 and the bus bar module 14 are accommodated with a filler is performed. The potting step S500 is performed in a posture in which the upper cover 20 is positioned below the stacked body 12 and the bus bar module 14 is positioned above the stacked body 12, that is, a posture in which the upper and lower sides of FIG. 1 are reversed. In the potting step S500, a fluid filler is injected into the case 10 from the bus bar module 14 side so that the gap of the stacked body 12 is filled with the filler.

In the potting step S500, the filler is cured when a predetermined time elapses under a predetermined condition after the filler is injected. The predetermined conditions and the predetermined time vary depending on the type and characteristics of the filler. By curing the filler injected into the case 10, the performance of fixing the position of the stacked body 12 inside the case 10 is improved, and structural characteristics, electrical characteristics, and environmental characteristics of the battery module 1 can be improved.

Here, if there is a gap in the vicinity of a cover (for example, the upper cover 20) that is positioned below the stacked body 12 at the time of performing potting, the filler may flow out of the stacked body 12 through the gap. When the filler flows out, filling of the filler becomes insufficient, and for example, the position of each member may not be appropriately fixed.

Therefore, in the method for manufacturing the battery module 1 of the present embodiment, the gap in the vicinity of the cover (for example, the upper cover 20) located below the stacked body 12 at the time of the potting step S500 is closed in a step before the potting step S500. For example, in the method for manufacturing the battery module 1 of the present embodiment, at least a part of a gap in the vicinity of the cover (for example, the upper cover 20) is filled with a part of an adhesive for bonding first end surfaces in the first direction (X direction in FIG. 2) of the cells 30 of the stacked body 12 and the cover (for example, the upper cover 20) bonded to the first end surfaces.

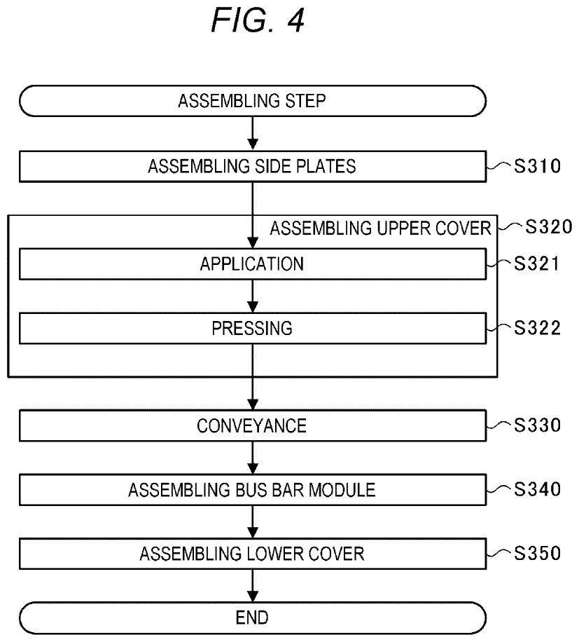

FIG. 4 is a flowchart illustrating a flow of the assembling step S300. As illustrated in FIG. 4, the assembling step S300 includes a side plate assembling step S310, an upper cover assembling step S320, a conveyance step S330, a bus bar module assembling step S340, and a lower cover assembling step S350. Each step of the assembling step may be performed by a manufacturing machine, may be performed by a person, or may be performed by cooperation of the manufacturing machine and the person.

In the side plate assembling step S310, the side plates 22 are bonded to both side surfaces of the stacked body 12 in the third direction (Z direction in FIG. 2, that is, the stacking direction of the units 50) via the adhesive.

In the upper cover assembling step S320, the upper cover 20 is bonded to the first end surface of each cell 30 of the stacked body 12 in the first direction (X direction in FIG. 2) via the adhesive. The first end surface of the cell 30 is, for example, one of two end surfaces in the first direction on which the electrode is not provided, in other words, an end surface opposite to end surfaces on which the electrodes are provided.

The upper cover assembling step S320 includes an application step S321 of applying an adhesive to the cells 30 and a pressing step S322 of pressing the upper cover 20 against the cells 30 applied with the adhesive. The upper cover assembling step S320 will be described in detail later.

In the conveyance step S330, the semi-finished product in which the side plate 22 and the upper cover 20 are assembled to the stacked body 12 is conveyed to the workplace of the bus bar module assembling step S340.

In the bus bar module assembling step S340, the bus bar module 14 is assembled to the conveyed semi-finished product. For example, the bus bar module 14 is fixed to the side plate 22 so that the bus bars 42 are arranged in the vicinity of the electrodes of the cells 30 of the stacked body 12.

In the lower cover assembling step S350, the lower cover 24 is assembled to the semi-finished product to which the bus bar module 14 is assembled. For example, the lower cover 24 is fixed to the side plate 22 so that the lower cover 24 is disposed on the side opposite to the stacked body 12 with respect to the bus bar module 14.

Note that the lower cover 24 may be permanently fixed to the bus bar module 14. In this case, the lower cover assembling step S350 may be substantially included in the bus bar module assembling step S340.

In addition, the lower cover assembling step S350 is not limited to the mode executed in the assembling step S300, and may be executed, for example, after the wire bonding step S400 or after the potting step S500.

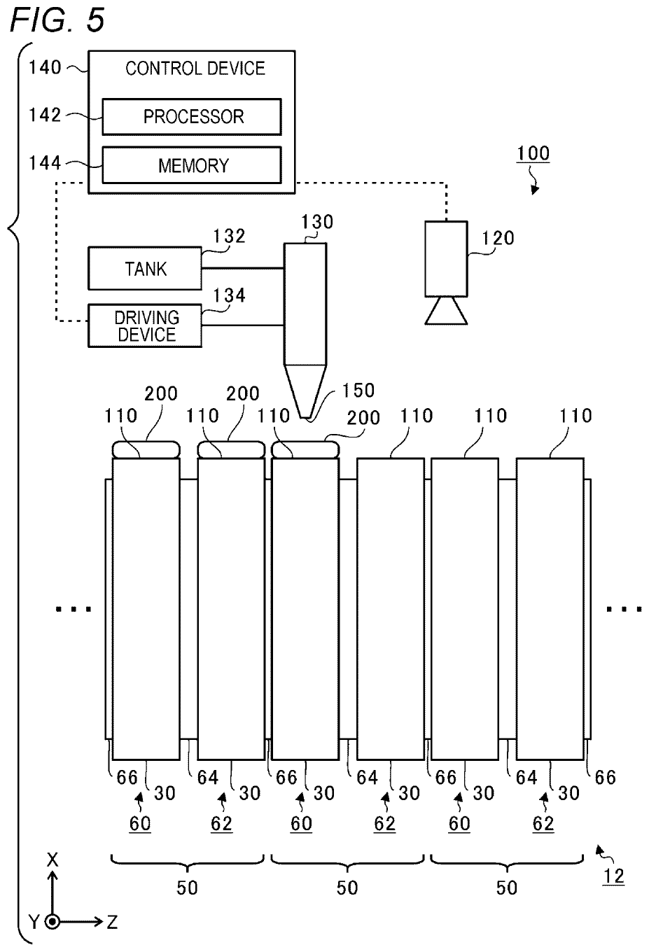

FIG. 5 is a schematic view illustrating an example of the application step S321 of the upper cover assembling step S320. FIG. 5 illustrates an example of an application system 100 that implements the application step S321. Hereinafter, the semi-finished product being manufactured as a target of the upper cover assembling step S320 may be referred to as a target semi-finished product.

The target semi-finished product is disposed in a posture in which first end surfaces 110 of the cells 30 of the stacked body 12 face vertically upward. As described above, the first end surfaces 110 are end surfaces opposite to the end surfaces on which the electrodes are provided.

As illustrated in FIG. 5, the application system 100 includes an imaging device 120, an application nozzle 130, a tank 132, a driving device 134, and a control device 140. Note that the application system 100 may include a stage on which the target semi-finished product is mounted and which is movable.

The imaging device 120 is capable of imaging at least a portion of the target semi-finished product. The application nozzle 130 is coupled to the tank 132. The tank 132 houses an adhesive 200. A tip portion 150 of the application nozzle 130 is directed to a central portion of the first end surface 110 of any one of the cells 30 in the parallel direction. Under the control of the control device 140, the driving device 134 can discharge the adhesive 200 stored in the tank 132 from the tip portion 150 of the application nozzle 130 and can move the application nozzle 130.

The control device 140 includes one or more processors 142 and one or more memories 144 coupled to the processor 142. The memory 144 includes a ROM in which a program and the like are stored and a RAM as a work area. The processor 142 executes various types of processing in cooperation with the program included in the memory 144.

The control device 140 can acquire an image captured by the imaging device 120. The control device 140 can control the driving device 134 by the processor 142 executing the program. For example, the control device 140 analyzes the acquired image to determine a position where the adhesive 200 is to be applied, and controls the driving device 134 to apply the adhesive 200.

In the application step S321 of the upper cover assembling step S320, as illustrated in FIG. 5, the control device 140 applies a larger amount of the adhesive 200 to the first end surfaces 110 of the cells 30 than the amount for bonding the first end surfaces 110 and the upper cover 20.

The adhesive 200 has fluidity to such an extent that at least its shape can be deformed when applied. In addition, the adhesive 200 may be cured while maintaining the bonding function when a predetermined time elapses under a predetermined condition after being applied.

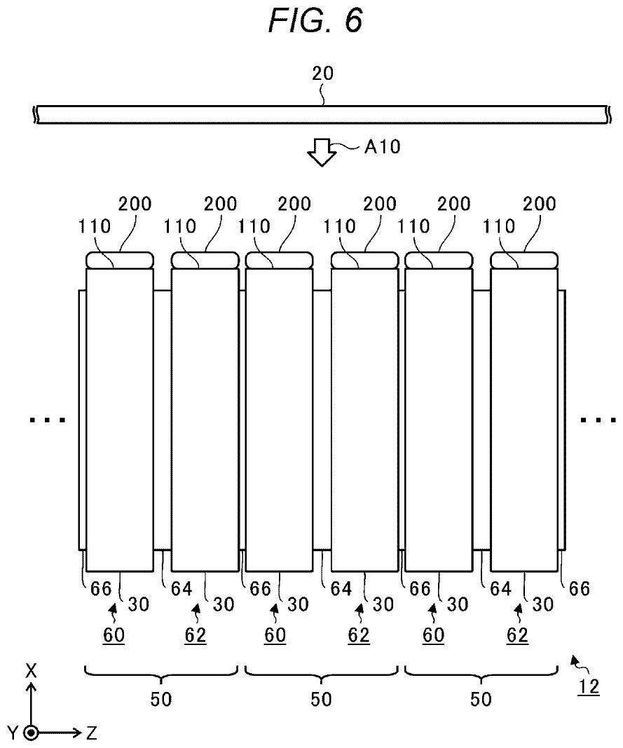

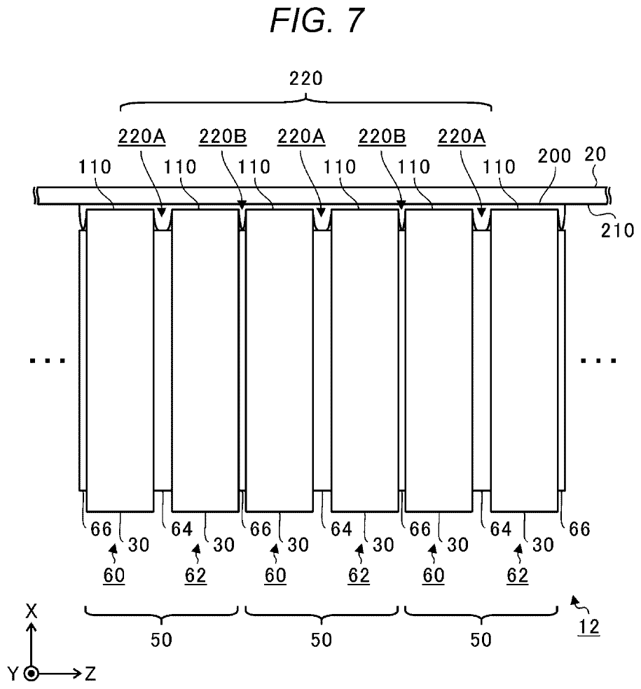

FIG. 6 is a schematic view illustrating an example of the pressing step S322 of the upper cover assembling step S320. FIG. 7 is a schematic view illustrating an example of a state after the pressing step S322 of the upper cover assembling step S320 is performed.

As indicated by an outlined arrow A10 in FIG. 6, in the pressing step S322, the upper cover 20 is moved in a direction approaching the first end surfaces 110 from vertically above the first end surfaces 110 of the cells 30 to which the adhesive 200 is applied, and the upper cover 20 is pressed against the first end surfaces 110.

When the upper cover 20 is pressed against the first end surfaces 110, as illustrated in FIG. 7, the first end surfaces 110 of the cells 30 and an inner surface 210 of the upper cover 20 are bonded via the adhesive 200.

As illustrated in FIG. 7, a side surface of the temperature control plate 64 on the side of the upper cover 20 is located closer to the inside of the stacked body 12 than the first end surfaces 110 of the cells 30. Therefore, first spaces 220A are formed by the inner surface 210 of the upper cover 20, the side surfaces of the cells 30 of the first cell group 60, the side surfaces of the cells 30 of the second cell group 62, and the side surface of the temperature control plate 64 on the upper cover 20 side.

Further, as illustrated in FIG. 7, a side surface of the insulating sheet 66 on the upper cover 20 side is located closer to the inside of the stacked body 12 than the first end surfaces 110 of the cells 30. Therefore, second spaces 220B are formed by the inner surface 210 of the upper cover 20, the side surfaces of the cells 30 of the first cell group 60, the side surfaces of the cells 30 of the second cell group 62, and the side surface of the insulating sheet 66 on the upper cover 20 side.

A thickness of the temperature control plate 64 in the stacking direction (Z direction in FIG. 7) may be larger than a thickness of the insulating sheet 66 in the stacking direction (Z direction in FIG. 7). In this case, the first spaces 220A may be wider than the second spaces 220B.

The first spaces 220A and the second spaces 220B are examples of a gap 220 located in the vicinity of the upper cover 20, and formed by the inner surface 210 of the upper cover 20 and the side surfaces of the cells 30. In other words, the gap 220 may include one or both of the first spaces 220A and the second spaces 220B.

As described above, in the application step S321 of the upper cover assembling step S320, a larger amount of the adhesive 200 than the amount for bonding the first end surfaces 110 and the upper cover 20 is applied to the first end surfaces 110 of the cells 30. Therefore, when the upper cover 20 is pressed against the first end surfaces 110 of the cells 30 in the pressing step S322, a part of the adhesive 200 overflows into the gap 220 in the vicinity of the upper cover 20 from between the first end surfaces 110 and the upper cover 20. For example, a part of the adhesive 200 overflows into the first spaces 220A and the second spaces 220B from between the first end surfaces 110 and the upper cover 20.

That is, in the pressing step S322, the adhesive 200 overflowing from between the first end surfaces 110 and the upper cover 20 fills at least a part of the gap 220 formed by the inner surface 210 of the upper cover 20 and the side surfaces of the cells 30. For example, at least a part of the first spaces 220A is filled with the overflowing adhesive 200. Similarly, at least a part of the second spaces 220B is filled with the overflowing adhesive 200.

Note that the disclosure is not limited to the aspect in which all the first spaces 220A among the first spaces 220A are filled with the adhesive 200, and one or more of the first spaces 220A among the first spaces 220A may be filled with the adhesive 200. In addition, the disclosure is not limited to the aspect in which the entire region of one first space 220A is filled with the adhesive 200, and at least a partial region of one first space 220A may be filled with the adhesive 200.

In addition, the disclosure is not limited to the aspect in which all the second spaces 220B among the second spaces 220B are filled with the adhesive 200, and one or more of the second spaces 220B among the second spaces 220B may be filled with the adhesive 200. Further, the disclosure is not limited to the aspect in which the entire region of one second space 220B is filled with the adhesive 200, and at least a partial region of one second space 220B may be filled with the adhesive 200.

Further, the disclosure is not limited to the aspect in which both the first spaces 220A and the second spaces 220B are filled with the adhesive 200, and either of the first spaces 220A and the second spaces 220B may be filled with the adhesive 200.

In this manner, when the gap 220 in the vicinity of the upper cover 20 is filled with the adhesive 200 for bonding the first end surfaces 110 of the cells 30 and the inner surface 210 of the upper cover 20, the gap 220 is substantially closed by the adhesive 200.

As described above, in the subsequent potting step S500, the upper cover 20 is brought into a posture positioned below the stacked body 12, and the fluid filler is injected into the stacked body 12. In the method for manufacturing the battery module 1 of the present embodiment, since the gap 220 in the vicinity of the upper cover 20 is closed by the adhesive 200, the filler is suppressed from flowing out of the stacked body 12 through the gap 220.

In addition, in the application step S321, the adhesive 200 may be applied to the first end surfaces 110 in an amount obtained by adding the volume of at least a part of the gap 220 in the vicinity of the upper cover 20 to the amount for bonding the first end surfaces 110 and the upper cover 20.

As described above, the battery module 1 of the present embodiment includes: the stacked body 12 including the stacked units 50 each including the first cell group 60 and the second cell group 62 in which the cells 30 extending in the first direction are arranged in the second direction orthogonal to the first direction, and the temperature control plate 64 disposed between the first cell group 60 and the second cell group 62 and extending in the second direction, and the cover (for example, the upper cover 20) bonded to the first end surfaces 110 in the first direction of the cells 30 of the stacked body 12. The method for manufacturing the battery module 1 of the present embodiment includes applying a larger amount of the adhesive 200 to the first end surfaces 110 of the cells 30 than the amount for bonding the first end surface 110 and the cover. The method for manufacturing the battery module 1 of the present embodiment includes bonding the first end surface 110 and the cover with the adhesive 200 interposed therebetween by pressing the cover against the first end surface 110 to which the adhesive 200 is applied, and filling at least a part of the gap 220 formed by the inner surface 210 of the cover and the side surface of the cell 30 with the adhesive 200 overflowing from between the first end surface 110 and the cover.

Thus, in the method for manufacturing the battery module 1 of the present embodiment, at least a part of the gap 220 is closed by the adhesive 200. Therefore, in the method for manufacturing the battery module 1 of the present embodiment, when the filler is injected into the stacked body 12 in the potting step S500, it is possible to suppress the filler from flowing out to the outside of the stacked body 12 through the gap 220. As a result, in the method for manufacturing the battery module 1 of the present embodiment, the filling with the filler in the potting step S500 can be appropriately performed.

In addition, in the method for manufacturing the battery module 1 of the present embodiment, at least a part of the gap 220 can be closed just by performing a simple operation for bonding the upper cover 20, that is, pressing the upper cover 20 against the first end surfaces 110 of the cells 30. Therefore, in the method for manufacturing the battery module 1 of the present embodiment, it is possible to suppress the manufacturing process from becoming complicated while suppressing the outflow of the filler in the potting step S500.

In addition, in the method of manufacturing the battery module 1 of the present embodiment, the gap 220 may include a space (for example, the first space 220A) formed by the inner surface 210 of the cover (for example, the upper cover 20), the side surfaces of the cells 30 of the first cell group 60, the side surfaces of the cells 30 of the second cell group 62, and the side surface on the cover side of the temperature control plate 64.

As a result, in the method for manufacturing the battery module 1 of the present embodiment, the first space 220A having a relatively large volume in the vicinity of the upper cover 20 is filled with the adhesive 200. Therefore, the outflow of the filler in the potting step S500 can be further suppressed.

Although the embodiment of the disclosure has been described above with reference to the accompanying drawings, it goes without saying that the disclosure is not limited to such an embodiment. It will be apparent to those skilled in the art that various changes or modifications can be conceived within the scope described in the claims, and it is understood that these naturally belong to the technical scope of the disclosure.

1. A method of manufacturing a battery module comprising: a stacked body including stacked units each including a first cell group and a second cell group in which cells extending in a first direction are arranged in a second direction orthogonal to the first direction, and a temperature control plate disposed between the first cell group and the second cell group and extending in the second direction; and a cover bonded to respective first end surfaces of the cells, the first end surfaces being in the first direction, the method comprising:
applying a larger amount of adhesive to the first end surfaces of the cells than an amount for bonding the first end surfaces and the cover; and
bonding the first end surfaces and the cover with the adhesive between the first end surfaces and the cover by pressing the cover against the first end surfaces to which the adhesive is applied, and filling at least a part of a gap formed by an inner surface of the cover and respective side surfaces of the cells with the adhesive overflowing from between the first end surfaces and the cover.

2. The method for manufacturing the battery module according to claim 1, wherein
the gap includes a space formed by the inner surface of the cover, the side surfaces of the cells of the first cell group, the side surfaces of the cells of the second cell group, and a side surface of the temperature control plate that is on a side of the cover.
